(19) United States
(12) Patent Application Publication
(10) Pub. No.: US 2019/0309839 A1
(43) Pub. Date: Oct. 10, 2019

(54) NOVEL ASSEMBLY OF A FLEXSPLINE AND A WAVE GENERATOR FOR A HARMONIC GEAR DRIVE

(71) Applicant: SHANGHAI F&S BEARING TECH CO., LTD., Shanghai (CN)

(72) Inventors: Lianchun ZHAO, Shanghai (CN); Sicheng ZHAO, Shanghai (CN); Shuying CHEN, Shanghai (CN)

(21) Appl. No.: 16/348,472

(22) PCT Filed: Dec. 20, 2016
(86) PCT No.: PCT/CN2016/111111

§ 371 Date: May 8, 2019

(30) Foreign Application Priority Data
Nov. 9, 2016 (CN) 201610986801.9
Nov. 9, 2016 (CN) 201621209452.1

(51) Int. Cl. F16H 49/00

(52) U.S. Cl. CPC F16H 49/001; F16H 2049/003

(57) ABSTRACT

An assembly of a flexspline and wave generator for harmonic gear drive uses an irregular-shaped ring flexible bearing to overcome problems with a conventional flexspline and wave generator: (1) The flexible bearing's outer ring skids with respect to the flexspline. The outer ring's rotating speed does not synchronize with flexspline's rotating speed. (2) The flexible bearing's outer ring made of bearing steel fractures and fails under repeated action of alternating bending stress. (3) The grooved raceway is deformed, geometric, shape, and position precision are greatly reduced. Press stress is turned into tensile stress on the working surface when the processed flexible bearing with higher precision is mounted with interference fit on a cam. (4) The flexible bearing's rolling ball has one contact point with the outer ring's raceway. When the flexspline is deformed in a radial direction, the flexspline warps in a tooth-width direction and deforms in a circumferential direction.

### BACKGROUND OF THE INVENTION

### Field of the Invention

The present invention relates to a novel assembly of a flexspline and a wave generator for a harmonic gear drive, particularly to a novel assembly of a flexspline and a wave generator and an irregular-shaped ring flexible bearing, wherein the assembly includes an irregular-shaped ring flexible bearing.

### Description of the Related Art

The harmonic gear drive uses the elastic deformation of a middle flexible member to realize movement or an assembly of power driving devices. The harmonic gear drive is famous for the deformation process of the middle flexible member based on a symmetric harmonic. The harmonic gear drive features high gear ratio, gear action for closed space, small volume, light weight, strong loading abilities, high gear precision, gear stabilities, and low noise, and has found application in many fields with high precision, such as aeronautical engineering, radar engineering, optical and mechanical engineering, industrial robots, weapon systems. The harmonic gear drive is composed of three components described as follows: (1) a harmonic generator composed of a cam (having a shape of ellipse) and a flexible bearing, wherein the outer ring of the flexible bearing is elliptically deformed as the cam rotates; (2) a flexspline having a shape of a thin shell and being an outer gear with elasticity; and (3) a rigid spline being a rigid inner gear. One of the three components is fixed, and the other components are respectively used as a driving component and a driven component. The three components provide a gearing-down mechanism or a gearing-up mechanism. Taking a harmonic gear decelerator (abbreviated as a harmonic decelerator) as an example. The flexspline is forced to continuously and elastically deform as the wave generator within the flexspline rotates. Since the wave generator continuously rotates, the flexspline sequentially repeats four engaging states, including those of “engaging-in”, “engaging-with”, “engaging-out”, and “separating” states. The phenomenon is called a staggered-tooth motion. The staggered-tooth motion turns the high-speed rotation into the low-speed rotation, thereby achieving the purpose of deceleration.

Except for the rigid spline, the other components are called an assembly of a flexspline and a wave generator. The assembly not only bends but also rotates during operation since the assembly includes a flexspline and a flexible bearing. The higher-pair repeated contact stress is generated between a rolling element within the flexible bearing and each contact pair of the raceway of a ring. The movement and behavior of the higher-pair repeated contact stress are very special and complicated. Thus, the rigid spline and the cam of the harmonic gear drive seldom fail. Instead, the flexspline or the flexible bearing (included in the wave generator) usually fails. As a result, the assembly of the flexspline and the wave generator is not only a key part of the harmonic gear drive but also a vulnerable part.

In the harmonic gear drive, the cam-type wave generator is very common. The cam-type wave generator includes a cam and a flexible bearing, wherein the cam is mounted with interference fit on the flexible bearing. In a dual-wave generator, the surface of the cam matched with the inner surface of the inner ring of the flexible bearing has a shape of an ellipse in cross section. In a triple-wave generator, the surface of the cam matched with the inner surface of the inner ring of the flexible bearing has a shape of a three-petaled round in cross section, and so on.

The cam is mounted with interference fit on the inner surface of the inner ring of the flexible bearing since the surface of the cam has a waveform profile (For example, an ellipse is used for a dual-wave drive. Taking a dual-wave drive and an ellipse as an example when there is no special explanation below.). Before installation, the inner ring of the bearing has a shape of a circle with high precision in cross section. After installation, the circle is forced to form an ellipse, which results in these problems: (1) The press stress on the processed grooved raceway of the inner ring is turned into a tensile stress. (2) The wall thickness difference between the grooved raceway and the inner surface and the depth difference between the grooved raceway and the rib of the grooved raceway increase manyfold. (3) Since the precise arc cross-section of the grooved raceway of the bearing is damaged, different positions of the grooved raceway have thus different shapes in cross section, including those of a groove width and a groove depth. The state of a rolling ball contacting an ideal arc grooved raceway disappears, and the states of the rolling ball contacting any positions of the grooved raceway are different. (4) Around the inner surface of the inner ring, any positions of the inner surface of the inner ring matched with the cam have different interferences. For example, two ends of a long axis of the ellipse have the largest interferences, two ends of a short axis of the ellipse may have clearance fits, and thus the precision of the moving trace of the rolling ball is influenced.

During installation, the inner ring of the flexible bearing and the cam are forced to form ellipses. Simultaneously, the center-distributed shape of all the rolling balls and the shape of the outer ring are forcedly turned from ideal shapes into ellipses. Since the wall of the flexspline is very thin, a small gap or a transition fit is designed between the flexspline and the outer surface of the outer ring of the flexible bearing (when each of the flexspline and the outer surface of the outer ring of the flexible bearing has a shape of a circle) in order to prevent from a non-given additional deformation caused by installation. However, the design causes some problems described as follows: (1) The outer ring and the flexspline use different kinds of steel to cause a problem with incompatible deformation since the outer is not matched with the flexspline too tight. After working for a while, the outer ring and the flexspline rotate relative to each other to cause the fretting wear and corrosion of the matched surfaces and reduce the gearing precision of the harmonic decelerator. (2) In general, the outer ring of the bearing is made of bearing steel, and the outer ring has sufficient hardness and insufficient toughness. The outer ring easily fractures and fails under the repeated action of bending stress.

A rolling ball within the flexible bearing has only one contact point with the single arc grooved raceway of the outer ring. That is to say, a single rolling ball provides one-point force for fittings of the outer ring and the flexspline, such that the fittings bend and deform. Consequently, the flexspline warps in a tooth-width direction and deforms in a circumferential direction when the flexspline is deformed in a radial direction.

Besides, the outer ring and the inner ring of the flexible bearing are very thin and narrow. After a mechanical process and heat treatment, the outer ring and the inner ring of the flexible bearing are easily deformed, thereby increasing the processing cost and reducing the processing precision.

The assembly of the flexspline and the wave generator and the members within the assembly have the abovementioned problems that reduce the precision, efficiency, and operating life of the harmonic gear drive. As a result, a novel assembly of a flexspline and a wave generator is required and developed to breakthrough the theoretical technology and the limitation to quality of the conventional assembly and improve the precision and operating reliability of the harmonic gear drive.

### SUMMARY OF THE INVENTION

As mentioned above, the conventional assembly of the flexspline and the wave generator has the abovementioned problems with the theoretical technology and the limitation to quality to reduce the precision, efficiency, and operating life of the harmonic gear drive. The novel assembly of a flexspline and a wave generator of the present invention is used to overcome the abovementioned problems and breakthrough the limitation of the conventional technology. The present invention breakthroughs the inertial thinking that an assembly of a flexspline and a wave generator is a three-piece suit composed of a flexspline, a flexible bearing, and a cam. The present invention integrates functions of the outer ring of a flexible bearing, a cam, and the inner ring of the flexible bearing. In other words, the present invention uses an irregular-shaped ring flexible bearing and a rolling element such as a roller and optimizes the shape of a raceway of the bearing in cross section to improve the operating precision and operating life of the flexspline and the wave generator. On the other hand, the present invention can improve the operating precision and operating life of the harmonic gear drive.

To achieve the abovementioned objectives, the present invention provides a novel assembly of a flexspline and a wave generator for a harmonic gear drive, wherein an outer surface of the assembly is meshed with teeth, an inner surface of the assembly has a hole and a groove connected with a drive shaft, the teeth of the outer surface is configured to generate a periodic elastic deformed wave according to a deformed regularity, the assembly comprises an irregular-shaped ring flexible bearing having at least one ring that is an irregular-shaped ring, a rolling element is embedded between two rings and separated by a cage in a circumferential direction, at least one of the two rings embedding the rolling element is an irregular-shaped ring, and the irregular-shaped ring flexible bearing is selected from one of three following bearings: (1) an inner ring is matched with an irregular-shaped outer ring to form an irregular-shaped outer ring flexible bearing; (2) an outer ring is matched with an irregular-shaped inner ring to form an irregular-shaped inner ring flexible bearing; and (3) an irregular-shaped outer ring is matched with an irregular-shaped inner ring to form an irregular-shaped double ring flexible bearing; and the irregular-shaped ring differs from a standard bearing ring having a tooth-free inner surface, a tooth-free outer surface, and a shape of a circle in cross section, so as to improve the operating precision and operating life of the assembly.

In an embodiment of the present invention, the assembly further comprises a cam when the irregular-shaped ring flexible bearing is the irregular-shaped outer ring flexible bearing, the inner surface of the inner ring of the irregular-shaped outer ring flexible bearing has interference fit with the outer surface of the cam, the inner surface of the irregular-shaped outer ring has a raceway, the outer surface of the irregular-shaped outer ring has teeth, and the irregular-shaped outer ring is a flexible ring.

In an embodiment of the present invention, the assembly further comprises a flexspline when the irregular-shaped ring flexible bearing is the irregular-shaped inner ring flexible bearing, an outer surface of the outer ring of the irregular-shaped inner ring flexible bearing has interference fit with an inner surface of the flexspline, an outer surface of the irregular-shaped inner ring is a cam, which has a raceway on its outer surface, the irregular-shaped inner ring is a rigid shaft, a shape of the raceway in cross section depends on the number of waves driven by a harmonic gear drive, the shape is an ellipse used for a double-wave drive, and the shape is a three-petaled round used for a triple-wave drive.

In an embodiment of the present invention, the irregular-shaped ring flexible bearing is the irregular-shaped double ring flexible bearing, an inner surface of the irregular-shaped outer ring has a raceway, an outer surface of the irregular-shaped outer ring has teeth, the irregular-shaped outer ring is a flexible ring, an outer surface of the irregular-shaped inner ring is a cam, which has a raceway on its outer surface, the irregular-shaped inner ring is a rigid shaft, the shape of the raceway of the cam in cross section depends on the number of waves driven by a harmonic gear drive, the shape is an ellipse used for a double-wave drive, and the shape is a three-petaled round used for a triple-wave drive.

In an embodiment of the present invention, the rolling element is a rolling ball, the ring or the irregular-shaped ring has a raceway, which is a single arc grooved raceway having one contact point with the rolling ball, or either an elliptic arc grooved raceway or a peach tip arc grooved raceway having two contact points with the rolling ball, and the irregular-shaped ring flexible bearing comprises an irregular-shaped ring two-point contact flexible ball bearing, an irregular-shaped ring three-point contact flexible ball bearing, or an irregular-shaped ring four-point contact flexible ball bearing according to the total contact points of the rolling ball and the raceways of either the outer ring or the irregular-shaped outer ring and either the inner ring or the irregular-shaped inner ring.

In an embodiment of the present invention, the rolling element is a roller, the raceway of the ring or the irregular-shaped ring is a straight raceway or a crowned curve type raceway, and the irregular-shaped ring flexible bearing is an irregular-shaped ring flexible roller bearing.

In an embodiment of the present invention, the grooved raceway crossed by a normal plane vertical to a tangent line to a corresponding point of a bottom of the grooved raceway includes the corresponding point and has a shape of a single arc, a pitch tip arc, or an elliptic arc.

In an embodiment of the present invention, the linear raceway crossed by a normal plane vertical to a tangent line to a corresponding point of the linear raceway includes the corresponding point and has a shape of a straight line or a crowned curve.

In an embodiment of the present invention, the irregular-shaped ring flexible roller bearing is an irregular-shaped inner ring flexible roller bearing or an irregular-shaped double ring flexible roller bearing, the raceway of the outer ring or the irregular-shaped outer ring does not have any rib, and the raceway of the irregular-shaped inner ring has a single rib or two ribs.

In an embodiment of the present invention, the irregular-shaped outer ring is made of carburized steel or alloy steel, the raceway of the irregular-shaped outer ring is processed by inductive quenching heat treatment, carburized treatment, or carbonitriding treatment, and the rolling element is made of bearing steel, stainless bearing steel, or engineering ceramic.

In an embodiment of the present invention, the irregular-shaped inner ring is made of bearing steel, stainless bearing steel, or medium-carbon steel, the raceway of the irregular-shaped inner ring is processed by inductive quenching heat treatment, carburized treatment, or carbonitriding treatment when the irregular-shaped inner ring is made of medium-carbon steel, and the rolling element is made of bearing steel, stainless bearing steel, or engineering ceramic.

The present invention provides an irregular-shaped ring flexible bearing, which has at least one ring that is an irregular-shaped ring, a rolling element is embedded between two rings and separated by a cage in a circumferential direction, at least one of the two rings embedding the rolling element is an irregular-shaped ring, and the irregular-shaped ring flexible bearing is selected from one of three following bearings: an inner ring is matched with an irregular-shaped outer ring to form an irregular-shaped outer ring flexible bearing; an outer ring is matched with an irregular-shaped inner ring to form an irregular-shaped inner ring flexible bearing; and an irregular-shaped outer ring is matched with an irregular-shaped inner ring to form an irregular-shaped double ring flexible bearing, thereby improving manufacturing, installing operating precision, and operating life of the bearing.

In an embodiment of the present invention, the irregular-shaped outer ring is made of carburized steel or alloy steel, the raceway of the irregular-shaped outer ring is processed by inductive quenching heat treatment, carburized treatment, or carbonitriding treatment, and the rolling element is made of bearing steel, stainless bearing steel, or engineering ceramic; or

the irregular-shaped inner ring is made of bearing steel, stainless bearing steel, or medium-carbon steel, the raceway of the irregular-shaped inner ring is processed by inductive quenching heat treatment, carburized treatment, or carbonitriding treatment when the irregular-shaped inner ring is made of medium-carbon steel, and the rolling element is made of bearing steel, stainless bearing steel, or engineering ceramic.

The assembly of the flexspline and the wave generator of the conventional technology comprises a cam, a flexible bearing, and a flexspline that are independent to each other. (1) Cam: The cam has a thicker wall. The cam is a rigid member. The outer surface of the cam matched with the inner surface of the inner ring of the bearing has a geometric profile, such as an ellipse. (2) Flexible bearing: The flexible bearing is a single-row shallow groove radial ball bearing. The ring of the flexible bearing has a very thin wall in a radial direction. The ring is very narrow. Due to processing deformation and heat deformation, the ring difficulty has high precision. After the ring is mounted with an interference fit on the cam, the shape of the ring in cross section is forcedly turned from a circle into a corresponding shape matched with the cam, such as an ellipse. (3) Flexible gear: The outer surface of the flexible gear has teeth (abbreviated as a flexspline). The inner surface of the flexspline is matched with the outer surface of the outer ring of the flexible bearing. Since the flexspline has a very thin wall, the flexspline is forced to have the shape of the outer surface of the bearing (at the same time, the shape of the outer surface of the bearing has been turned into the matched surface of the cam, such as an ellipse) after the flexspline is matched with the outer surface of the outer ring of the flexible bearing. The assembly of the flexspline and the wave generator of the conventional technology may be called a three-piece suit, which is related to a part of the abovementioned problems.

The novel assembly of the flexspline and the wave generator of the present invention breakthroughs the inertial thinking of the three-piece suit and uses the integration of the flexible bearing and the flexspline and the integration of the flexible bearing and the cam, such that the three-piece suit is changed into a two-piece suit or one-piece suit, thereby reducing the number of members, overcoming the problems with technical quality due to combining three components, and improving the operating precision and operating life of the assembly. In addition, the novel assembly of the present invention may use a roller-type bearing not used by the three-piece suit. The novel assembly of the present invention uses an irregular-shaped ring flexible bearing, including those of an irregular-shaped outer ring flexible bearing, an irregular-shaped inner ring flexible bearing, and an irregular-shaped double ring flexible bearing.

The outer ring of the irregular-shaped outer ring flexible bearing is an irregular-shaped ring. The shape of the irregular-shaped ring is different from the shape of the outer ring of the conventional flexible bearing. The irregular-shaped ring has a very thin wall. The outer surface of the irregular-shaped ring has teeth (also called flexspline teeth). The teeth engage with the teeth of the rigid spline to perform variable speed drive. The inner surface of the irregular-shaped ring has a raceway. The raceway has a shape of a single arc in cross section when the bearing is an irregular-shaped outer ring two-contact point flexible ball bearing. The raceway has a shape of a pitch tip or an elliptic arc in cross section when the bearing is an irregular-shaped outer ring three-contact or four-contact point flexible ball bearing. The raceway has a shape of a straight line or a crowned curve in cross section when the bearing is an irregular-shaped outer ring line contact flexible roller bearing. Within the range of a width corresponding to the flexspline, the wall of the irregular-shaped outer ring in a radial direction is thicker than the walls of the conventional flexspline and the outer ring of the conventional flexible bearing in a radial direction. The specifications are advantageous to reducing the workpiece clamping deformation during processing time to obtain the high precision of the flexspline and the raceway. Besides, the irregular-shaped outer ring is processed to form the flexspline and the grooved raceway in a clamping and positioning process. Alternatively, the flexspline and the grooved raceway may be used as each other's positioning bases. This way, the positional precision of the flexspline and the raceway is greatly improved. When the harmonic gear drive operates, the integrated outer ring periodically bends and deforms as the inner ring or the irregular-shaped inner ring rotates. Thus, the irregular-shaped outer ring is made of carburized steel or alloy steel with high strength and high flexibility. In order to improve the wear-resisting and anti-stripping abilities of the raceway, the surface of the raceway is processed by inductive quenching heat treatment, carburized treatment, or carbonitriding treatment. When the raceway of the irregular-shaped outer ring is a peach tip arc grooved raceway, an elliptic arc grooved raceway, or a linear raceway, a single rolling element has two or more contact points with the raceway. For the conventional technology, the rolling ball of a flexible bearing has one contact point with a single arc grooved raceway. Compared with the conventional technology, warps along a tooth-width direction of the flexspline and twists along a circumferential direction of the flexspline under the action of contact force provided by the rolling element can be reduced or avoided when the flexspline is functionally deformed in a given radial direction. The irregular-shaped outer ring flexible bearing is matched with a cam to form a novel assembly of a flexspline and a wave generator, which is a two-piece suit. The novel assembly overcomes the problems with skidding, fretting wear, and asynchronous operation for the outer ring of the flexible bearing and the flexspline and avoids a fact that the outer ring of the flexible bearing made of low-toughness material, such as bearing steel, easily fractures and fails under the repeated action of bending stress.

The inner ring of the irregular-shaped inner ring flexible bearing is an irregular-shaped ring, which is different from the inner ring of the conventional flexible bearing, wherein the inner ring of the conventional flexible bearing has a thin wall and a narrow width. The outer surface of the cam is directly processed to form the raceway. The cross section of the raceway and the outer surface of the cam have the same center and the similar geometric shapes. For a double-wave drive, the cross section of the raceway and the outer surface of the cam have the same center and the similar ellipses. For a triple-wave drive, the cross section of the raceway and the outer surface of the cam have the same center and the similar three-petaled round. Since the wall of the cam is thicker and the depth of the raceway of the bearing is shallower, the wall of the irregular-shaped inner ring is thicker. Thus, the irregular-shaped inner ring is a rigid ring/shaft rather than a flexible ring, which is very advantageous to obtaining the high processing precision. In addition, the geometric precision obtained during processing time keeps unchanged during and after installation. Before installation, the raceway of the irregular-shaped outer ring has a shape of a circle in cross section. Before installation, the raceway of the irregular-shaped inner ring has a shape of an ellipse or a three-petaled round in cross section, not a shape of a circle in cross section. After installation, the shape in cross section keeps unchanged. The raceway crossed by normal planes respectively passing all points of the bottom of the raceway has the same shapes, such as single arcs, elliptic arcs, peach tips each formed by two semi-arcs, or straight lines, and the same shapes keep unchanged during and after installation. As a result, compared with the flexible bearing of the conventional technology, the irregular-shaped inner ring flexible bearing of the present invention has obvious advantages in precision after installation. The advantages include operating stabilities, low noise, low friction torque, and low temperature-rising under operating conditions. Two features should be noted as follows: (1) The irregular-shaped inner ring has a shape of an ellipse or a three-petaled round in cross section. The normal planes respectively passing all the points of the bottom of the raceway does not necessarily pass the center of the ellipse or the three-petaled round. Taking a raceway having a shape of an ellipse in cross section as example. The normal plane passing four ends (two ends of a long axis and two ends of a short axis) of the ellipse passes the center of the ellipse, and the normal planes passing the other points of the bottom of the raceway do not pass the center of the ellipse. (2) The raceway having a shape of an ellipse in cross section and an elliptic arc raceway belong to two different concepts. The central axis of the irregular-shaped inner ring is perpendicular to the irregular-shaped inner ring. The raceway having a shape of an ellipse in cross section represents that the raceway crossed by the central axis of the irregular-shaped inner ring has a shape of an ellipse. The elliptic arc raceway represents that the raceway crossed by normal planes respectively passing all points of the bottom of the raceway has shapes of elliptic arcs. The elliptic arc raceway is a grooved raceway. The grooved raceway has two contact points with a rolling ball. The grooved raceway is used by a three-point contact ball bearing or a four-point contact ball bearing.

The irregular-shaped inner ring is made of bearing steel or medium-carbon steel. The surface of the raceway of the irregular-shaped inner ring is processed by inductive quenching heat treatment, carburized treatment, or carbonitriding treatment when the irregular-shaped inner ring is made of medium-carbon steel. This way, the roughness of the body of the inner ring and the wear-resisting and anti-stripping abilities of the surface of the raceway are concerned.

The irregular-shaped inner ring flexible bearing is matched with the flexspline to form a novel assembly of a flexspline and a wave generator. The novel assembly is a two-piece suit, which avoids a fact that the grooved raceway is deformed, the geometric precision and the precision of shape and position are greatly reduced, and the press stress is turned into a tensile stress on the working surface during processing time when the processed flexible bearing with higher precision is mounted with an interference fit on the cam, thereby improving the operating precision and operating reliability.

As mentioned above, in order to reduce or avoid warps along the tooth-width direction of the flexspline and twists along the circumferential direction of the flexspline, the number of points that the rolling element of the flexible bearing contacts the raceway of the outer ring should be increased. Normally, the best choice is a line contact roller bearing having infinite contact points. However, the conventional assembly of the flexspline and the wave generator does not use a flexible roller bearing. The reason for this is that the roller bearing needs to have ribs. Nevertheless, the outer ring and the inner ring of the flexible bearing do not have any rib since the outer ring and the inner ring of the flexible bearing need to bend or deform. The rib is equivalent to a stiffener, such as L-shaped steel or I-shaped steel. Thus, the outer ring and the inner ring of the flexible bearing are difficulty deformed or unable to be deformed. For the irregular-shaped inner ring flexible bearing, the flexible bearing is realized with a roller bearing. Since the irregular-shaped inner ring need not deform during installing and using processes, an irregular-shaped inner ring roller bearing is fabricated, wherein the inner ring of the irregular-shaped inner ring roller bearing has two ribs. (Of course, the inner ring of the irregular-shaped inner ring roller bearing alternatively has one rib. Some elements are required and installed on the inner ring to limit the movement of the roller toward a side of the inner ring without any rib.) The irregular-shaped inner ring roller bearing is matched with the flexspline to form the novel assembly of the flexspline and the wave generator, which has the higher operating precision and the longer serving life.

The irregular-shaped double ring flexible bearing itself refers to the novel assembly of the flexspline and the wave generator. The irregular-shaped double ring flexible bearing is a one-piece suit. The assembly has the advantages of the irregular-shaped outer ring flexible bearing and the irregular-shaped inner ring flexible bearing, thereby achieving the very high precision and the very long serving life.

For the purpose of intuition, the comparisons between the novel assembly of the flexspline and the wave generator including the irregular-shaped ring flexible bearing and the conventional assembly of the flexspline and the wave generator in structure, precision, processing properties, and performance are listed in the following table.

| | Conventional assembly of | Assembly of flexspline and wave generator |
|---|---|---|
| | flexspline and wave | including irregular-shaped ring flexible |
| Comparing items | generator | bearing |
| Members to | (1) Cam; | Assembly including irregular-shaped outer |
| be included | (2) Flexible bearing; | ring flexible bearing: (1) cam; (2) |
| | (3) Flexspline | irregular-shaped outer ring flexible bearing |
| | | Assembly including irregular-shaped inner |
| | | ring flexible bearing: (1) irregular-shaped |
| | | inner ring flexible bearing; (2) flexspline |
| | | Assembly including irregular-shaped double |
| | | ring flexible bearing: (1) irregular-shaped |
| | | double ring flexible bearing |
| Detachable | (1) Cam; | Assembly including irregular-shaped outer |
| component to be | (2) Inner ring of flexible | ring flexible bearing: (1) cam; (2) inner ring |
| included | bearing; | of flexible bearing; (3) inner ring of flexible |
| | (3) Rolling element; | bearing; (4) cage; (5) irregular-shaped outer |
| | (4) Cage; | ring |
| | (5) Outer ring of flexible | Assembly including irregular-shaped inner |
| | bearing | ring flexible bearing: (1) irregular-shaped |
| | (6) Flexspline | inner ring; (2) rolling element; (3) cage; (4) |
| | | outer ring of flexible bearing; (5) flexspline |
| | | Assembly including irregular-shaped double |
| | | ring flexible bearing: (1) irregular-shaped |
| | | inner ring; (2) rolling element; (3) cage; (4) |
| | | irregular-shaped outer ring |
| Shape, material, | Outer ring of bearing has a | Irregular-shaped outer ring is a bearing ring |
| and flexibility of | standard thin wall; | with an non-standard thin wall; |
| outer ring of | Outer ring of bearing is | Irregular-shaped outer ring is wider; |
| bearing | very narrow; | Outer surface of irregular-shaped outer ring |
| | Bearing steel; | has flexspline; |
| | Flexible ring | Carburized steel or alloy steel; |
| | | Surface of a raceway is processed by |
| | | inductive quenching heat treatment; |
| | | Flexible ring |
| Shape, material, | Inner ring of bearing has a | Irregular-shaped inner ring is an non-standard |
| and flexibility of | standard thin wall; | shaft coupling ring, which is a longer solid |
| inner ring of | Inner ring of bearing is | camshaft or a longer hollow camshaft; |
| bearing | very narrow; | Raceway of ring is formed on the outer |
| | Bearing steel; | surface of the shaft; |
| | Flexible ring | Bearing steel or medium-carbon steel; |
| | | Surface of a raceway is processed by |
| | | inductive quenching heat treatment; |
| | | Rigid ring/shaft |
| Processing cost | Inner ring is a flexible ring; | Irregular-shaped inner ring is a Rigid |
| and precision to | High processing cost; | ring/shaft; |
| be obtained of | Low precision to be | Low processing cost; |
| inner ring of | obtained | High precision to be obtained |
| bearing | | |
| Shape of raceway | Single arc grooved raceway | (1) single arc grooved raceway, (2) elliptic |
| of outer ring of | | arc grooved raceway, (3) peach tip arc |
| bearing (before | | grooved raceway, or (4) linear raceway |
| installation) | | |
| Shape of raceway | Single arc grooved raceway | (1) single arc grooved raceway, (2) elliptic |
| of inner ring of | is strict; | arc grooved raceway, (3) peach tip arc |
| bearing (before | Around circular ring, any | grooved raceway, or (4) linear raceway |
| installation) | positions of grooved | |
| | raceway have the same | |
| | depths | |
| Shape of raceway | During installation, | Irregular-shaped inner ring is an non-standard |
| of inner ring of | circle-shaped inner ring is | shaft coupling ring, which is a rigid |
| bearing (after | turned into an | ring/shaft; |
| installation) | ellipse-shaped inner ring; | Irregular-shaped inner ring obtains high |
| | Grooved raceway does not | precision before installation; |
| | have a shape of a strict arc | Irregular-shaped inner ring keeps unchanged |
| | in cross section; | after installation |
| | Around ellipse-shaped | |
| | inner ring, any positions of | |
| | grooved raceway have | |
| | different depths | |
| Circumferential | Possible | Not applicable |
| movement of | | |
| inner ring with | | |
| respect to cam | | |
| during operating | | |
| process | | |
| Circumferential | Circumferential movement | Not applicable |
| movement of | has a higher probability | |
| outer ring with | since outer ring is not | |
| respect to | matched with flexspline | |
| flexspline during | tightly and the materials of | |
| operation | outer ring and flexspline | |
| | are very different | |
| Fracture and | Outer ring has very high | Irregular-shaped outer ring is difficultly |
| failure of outer | hardness and insufficient | fractures and fails since irregular-shaped |
| ring during | toughness and easily | inner ring is made of carburized steel or alloy |
| operation | fractures and fails since | steel |
| | outer ring is made of | |
| | bearing steel | |
| Number of points | Single arc grooved raceway | Single arc grooved raceway and one point; |
| of single rolling | and one point | Either elliptic arc grooved raceway or peach |
| element applying | | tip arc grooved raceway and two points; |
| force to member | | Linear raceway and infinite points |
| where flexspline is | | |
| located during | | |
| operation | | |
| Possibility and | One-point force; | One point, two points, or infinite points; |
| degree of | High possibility of | the more the number of points, the lower the |
| additional | deformation; | possibility of deformation, and the lower the |
| deformation of | High degree | degree |
| flexspline in axial | | |
| and | | |
| circumferential | | |
| directions during | | |
| operation | | |
| Determine | No, two rings do not have | Yes, irregular-shaped inner ring has a rib |
| whether flexible | any rib | |
| bearing is realized | | |
| with roller bearing | | |
| Operating | Low | High |
| precision | | |
| Operating | Low | High |
| reliability and life | | |

Below, the embodiments are described in detail in cooperation with the drawings to make easily understood the technical contents, characteristics and accomplishments of the present invention.

### BRIEF DESCRIPTION OF THE DRAWINGS

FIG. 1 is a cross-sectional perspective view of a cam in the conventional technology;

FIG. 2 is a diagram schematically showing a flexible bearing in the conventional technology;

FIG. 3 is a diagram schematically showing a wave generator in the conventional technology;

FIG. 4 is a diagram schematically showing a flexspline in the conventional technology;

FIG. 5 is a diagram schematically showing an assembly of a flexspline and a wave generator in the conventional technology;

FIG. 6 is a diagram schematically showing an irregular-shaped inner ring of an irregular-shaped inner ring flexible bearing according to an embodiment of the present invention;

FIG. 7 is a diagram schematically showing a raceway of an irregular-shaped ring flexible bearing crossed by a normal plane according to an embodiment of the present invention; (A) single arc; (B) elliptic arc; (C) peach tip arc; and (D) straight line with two ribs

FIG. 8 is a diagram schematically showing an irregular-shaped outer ring of an irregular-shaped outer ring flexible bearing according to an embodiment of the present invention;

FIG. 9 is a diagram schematically showing an irregular-shaped inner ring flexible ball bearing according to an embodiment of the present invention;

FIG. 10 is a diagram schematically showing a novel assembly of a flexspline and a wave generator including an irregular-shaped double ring flexible ball bearing according to an embodiment of the present invention;

FIG. 11 is a diagram schematically showing a novel assembly of a flexspline and a wave generator including an irregular-shaped double ring flexible roller bearing according to an embodiment of the present invention;

FIG. 12 is a diagram schematically showing a novel assembly of a flexspline and a wave generator including an irregular-shaped inner ring flexible ball bearing according to an embodiment of the present invention; and

FIG. 13 is a diagram schematically showing a novel assembly of a flexspline and a wave generator including an irregular-shaped outer ring flexible ball bearing according to an embodiment of the present invention.

### DETAILED DESCRIPTION OF THE INVENTION

FIG. 1 is a cross-sectional perspective view of a cam in the conventional technology. The hole of the cam has a key slot matched with an input/output shaft. The outer surface of the cam is not a surface, but a curved surface, wherein the curved surface is designed according to the number of waves driven by a harmonic generator. The curved surface is an elliptic surface used for a double-wave drive. The curved surface has a shape of a three-petaled round used for a triple-wave drive. The curved surface has a four-petaled round used for a quadruple-wave drive. The double-wave drive is very common. Thus, the cam of FIG. 1 has a shape of an ellipse in cross section.

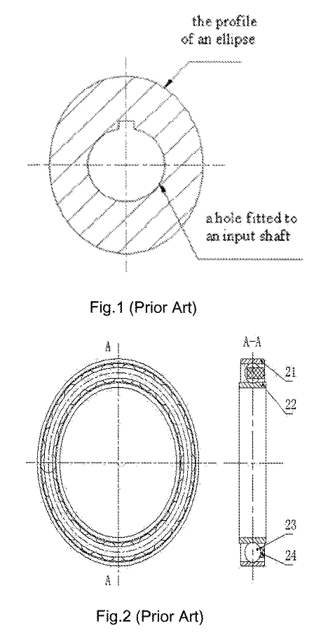

FIG. 2 is a diagram schematically showing a flexible bearing in the conventional technology. The flexible bearing is a single-row shallow groove radial ball bearing. 21 represents an outer ring with a thin wall, 22 represents an inner ring with a thin wall, 23 represents a rolling ball, and 24 represents a cage. Before installation, the center of each of the outer ring, the inner ring, and the rolling ball has a shape of a circle in cross section, as shown in FIG. 2. The outer ring and the inner ring of the conventional flexible bearing are made of bearing steel.

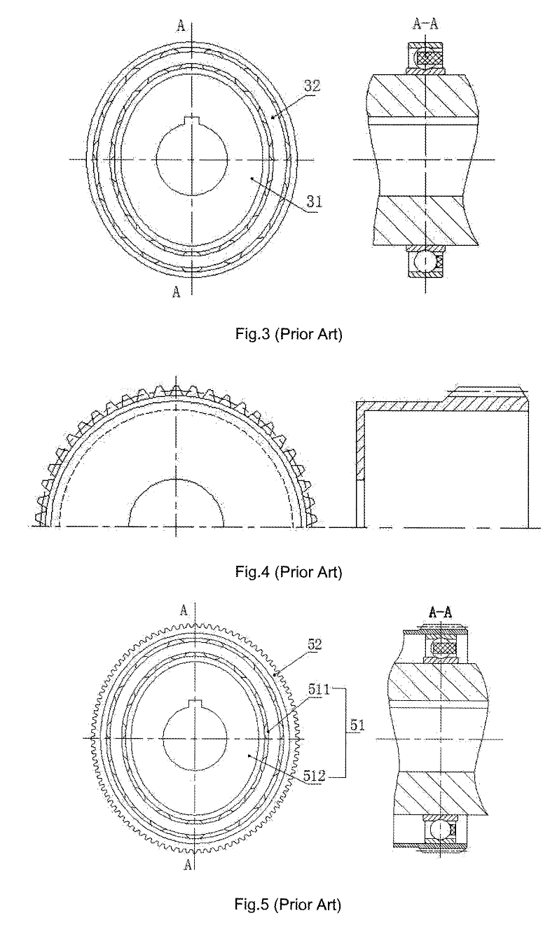

FIG. 3 is a diagram schematically showing a wave generator in the conventional technology. The wave generator of FIG. 3 is formed by installing the flexible bearing of FIG. 2 with the cam of FIG. 1. In FIG. 3, 31 represents a cam and 32 represents a flexible bearing. The inner surface of the flexible bearing is mounted with an interference fit on the outer surface of the cam. After installation, the cross-sectional shape of the center of each of the outer ring and the inner ring of the flexible bearing is forcedly turned from a circle into an ellipse corresponding to the shape of the cam, wherein the ellipse and the cross-sectional elliptic shape of the outer surface of the cam have the same center.

FIG. 4 is a diagram schematically showing a flexspline in the conventional technology. In the conventional technology, the flexspline has various types. The various types of the flexsplines have the same properties described as follows. (1) Thin wall. (2) The outer surface of the flexspline has teeth with a width to engage with the teeth of a rigid spline. For convenience, the teeth engaging with the rigid spline are called the flexspline (the flexspline is possessed by a flexible gear or an irregular-shaped outer ring.) Before installation, the flexspline has a shape of a circle in cross section.

FIG. 5 is a diagram schematically showing an assembly of a flexspline and a wave generator in the conventional technology. The assembly of the flexspline and the wave generator is formed by installing the flexspline of FIG. 4 with the wave generator of FIG. 3. After installation, the cross-sectional shape of the flexspline is forcedly turned from a circle into an ellipse corresponding to the shape of the wave generator. 51 represents the wave generator including a flexible bearing 511 and a cam 512. 52 represents a flexspline.

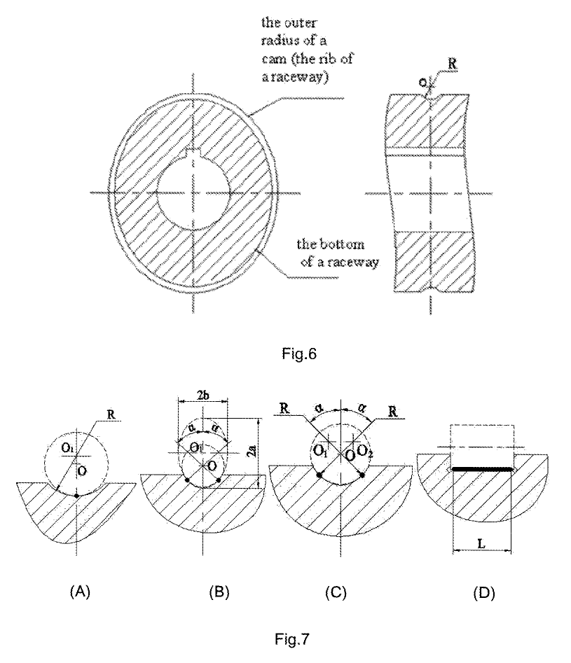

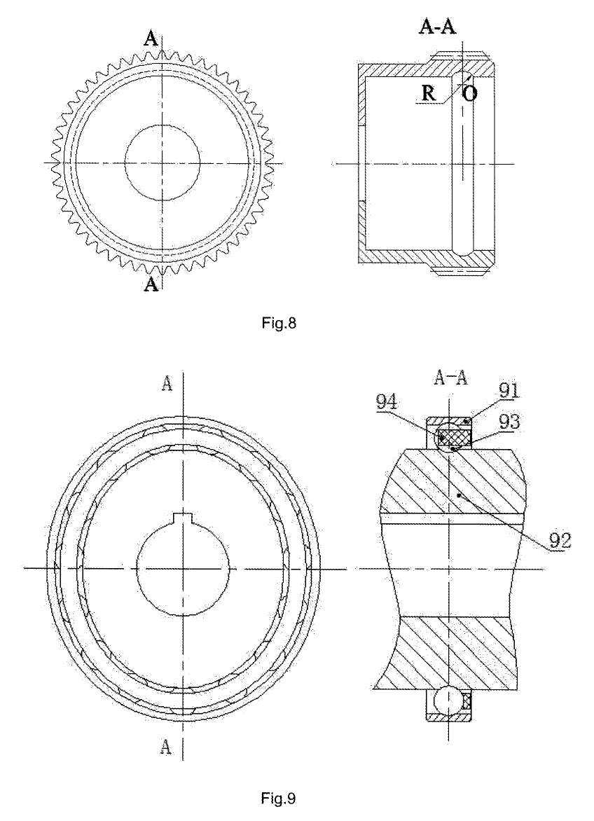

FIG. 6 is a diagram schematically showing an irregular-shaped inner ring of an irregular-shaped inner ring flexible bearing according to an embodiment of the present invention. The inner ring of the irregular-shaped inner ring flexible bearing is abbreviated as the irregular-shaped inner ring. The irregular-shaped inner ring is formed by integrating the conventional inner ring with the conventional cam. Except for the inner ring of the conventional flexible bearing, the raceway of the inner ring of the conventional flexible bearing is directly formed on the cam to fabricate the irregular-shaped inner ring. FIG. 6 shows an elliptic cam and a single arc grooved raceway. The left inset of FIG. 6 shows a cross-sectional view of the irregular-shaped inner ring in a horizontal direction, and the right inset of FIG. 6 shows a cross-sectional view of the irregular-shaped inner ring in a longitudinal direction. From FIG. 6, it is known that the bottom and the rib of the grooved raceway both have ellipses in cross section. The grooved raceway crossed by normal planes corresponding to any points of the bottom of the grooved raceway has the same profiles. The shape of the raceway of the irregular-shaped inner ring is shown in FIG. 7(A), FIG. 7(B), FIG. 7(C), or FIG. 7(D). FIG. 6 corresponds to FIG. 7(A) showing a single arc grooved raceway, wherein O represents the center of the arc and R represents the radius of the arc.

FIG. 7 is a diagram schematically showing a raceway of an inner ring or an outer ring crossed by a normal plane according to an embodiment of the present invention. In order to reduce warps along a tooth-width direction of the flexspline and twists along a circumferential direction of the flexspline, the number of points that a rolling element contacts the raceway of the outer ring should be increased by changing the cross-sectional shape of the raceway. As shown in FIG. 7(A), the raceway has a shape of a single arc in cross section. O₁ represents the center of the arc and R represents the radius of the arc. The arc has one contact point with a rolling ball having a center O. A contact angle between the arc and the rolling ball has 0 degree. As shown in FIG. 7(B), the raceway has a shape of an elliptic arc with a variable curvature in cross section. The length of a long axis of an ellipse corresponding to the elliptic arc is 2a, and the length of a short axis of the ellipse corresponding to the elliptic arc is 2b. The long axis intersects the short axis at O₁. The elliptic arc has two contact points with a rolling ball having a center O. A contact angle between the elliptic arc and the rolling ball has a degrees. As shown in FIG. 7(C), the raceway has a shape of a peach tip arc formed by two half arcs in cross section. O₁ represents the center of the right half arc, O₂ represents the center of the left half arc, and R represents the radius of each of the two half arcs. The peach tip arc has two contact points with a rolling ball having a center O. A contact angle between the rolling ball and each of the two half arcs has a degrees. As shown in FIG. 7(D), the raceway has a shape of a straight line with two ribs in cross section. The area that the raceway contacts a roller has a length of L and infinite contact points. Only the irregular-shaped inner ring of an irregular-shaped inner ring flexible roller bearing or an irregular-shaped double ring flexible roller bearing has a linear raceway with two ribs. Refer to FIG. 7. For point contact, a contact point is represented by a black solid point. For line contact, infinite contact points are represented by a black thick solid line.

FIG. 8 is a diagram schematically showing an irregular-shaped outer ring of an irregular-shaped outer ring flexible bearing according to an embodiment of the present invention. The outer ring of the irregular-shaped outer ring flexible bearing is abbreviated as the irregular-shaped outer ring. The irregular-shaped outer ring is formed by integrating the conventional outer ring with the conventional flexspline. Except for the outer ring of the conventional flexible bearing, the raceway of the outer ring of the conventional flexible bearing is directly formed on the flexspline to fabricate the irregular-shaped outer ring. From FIG. 8, it is known that the irregular-shaped outer ring has a shape of a circle in cross section before installation. The shape of the raceway of the irregular-shaped outer ring is shown in FIG. 7(A), FIG. 7(B), or FIG. 7(C). Alternatively, the raceway of the irregular-shaped outer ring is a linear raceway without any rib. FIG. 8 corresponds to FIG. 7(A) showing a single arc grooved raceway.

FIG. 9 is a diagram schematically showing an irregular-shaped inner ring flexible ball bearing according to an embodiment of the present invention. The irregular-shaped inner ring flexible ball bearing is formed by fitting the irregular-shaped inner ring 92 of FIG. 6, the conventional outer ring 91 of FIG. 2, and rolling balls 93. All the rolling balls are uniformly separated by a cage 94 in a circumferential direction. Since the grooved raceway of the irregular-shaped inner ring 92 has a shape of ellipse in cross section, the diameters of all the rolling balls form an ellipse and the outer ring has a shape of an ellipse in cross section. As shown in FIG. 9, the ring has a grooved raceway, which has a shape of a single arc, an elliptic arc, or a peach tip arc in cross section. The single arc has one contact point with the rolling ball. The elliptic arc or the peach tip arc has two contact points with the rolling ball.

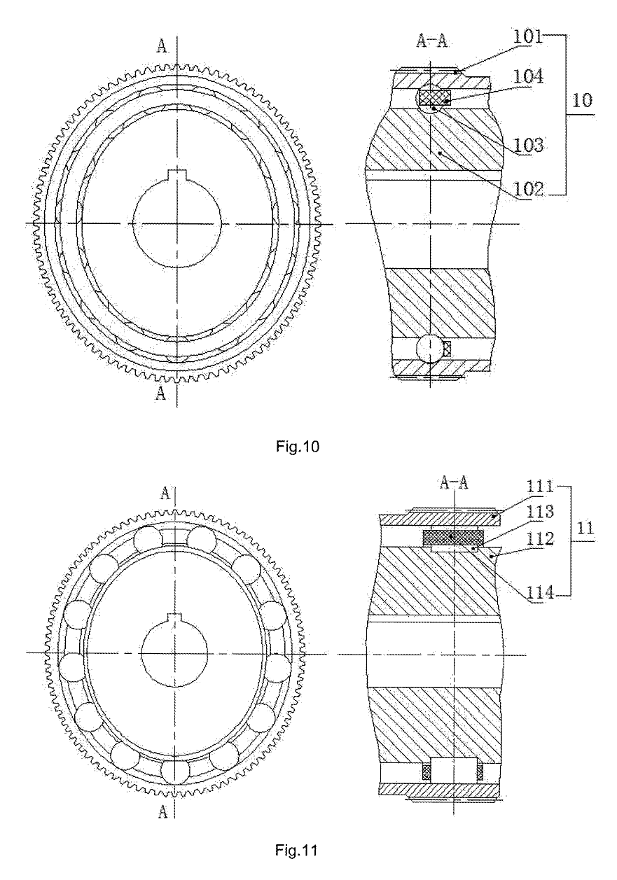

FIG. 10 is a diagram schematically showing a novel assembly of a flexspline and a wave generator including an irregular-shaped double ring flexible ball bearing according to an embodiment of the present invention. The irregular-shaped double ring flexible ball bearing is the novel assembly of the flexspline and the wave generator. The irregular-shaped double ring flexible ball bearing has all functions of the novel assembly of the flexspline and the wave generator. The irregular-shaped double ring flexible ball bearing 10 is formed by fitting the irregular-shaped outer ring 101 of FIG. 8, the irregular-shaped inner ring 102 of FIG. 6, and rolling balls 103. All the rolling balls 103 are uniformly separated by a cage 104 in a circumferential direction. Since the raceway of the irregular-shaped inner ring has a shape of ellipse in cross section, a curve connecting the centers of all the rolling balls forms an ellipse and the irregular-shaped outer ring has a shape of an ellipse in cross section. As shown in FIG. 10, the ring has a grooved raceway, which has a shape of a single arc, an elliptic arc, or a peach tip arc in cross section. The single arc has one contact point with the rolling ball. The elliptic arc or the peach tip arc has two contact points with the rolling ball.

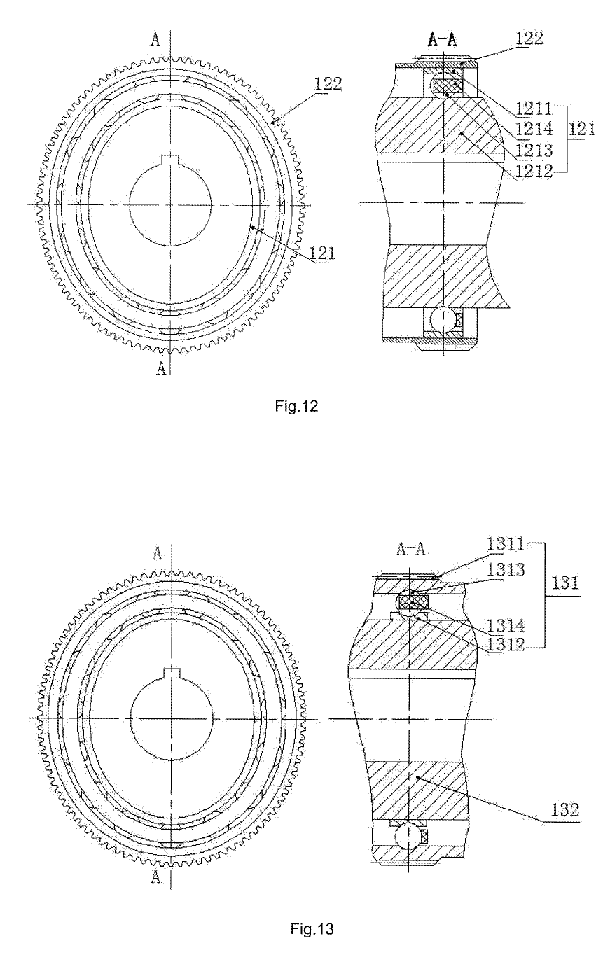

FIG. 11 is a diagram schematically showing a novel assembly of a flexspline and a wave generator including an irregular-shaped double ring flexible roller bearing according to an embodiment of the present invention. The novel assembly of the flexspline and the wave generator is irregular-shaped double ring flexible roller bearing. The irregular-shaped double ring flexible roller bearing has all functions of the novel assembly of the flexspline and the wave generator. The irregular-shaped double ring flexible roller bearing is formed by fitting the irregular-shaped outer ring 111 of FIG. 8, the irregular-shaped inner ring 112 of FIG. 6, and rollers 113. All the rollers 103 are uniformly separated by a cage 114 in a circumferential direction. Since the raceway of the irregular-shaped inner ring has a shape of ellipse in cross section, a curve connecting the centers of all the rollers forms an ellipse and the irregular-shaped outer ring has a shape of an ellipse in cross section. As shown in FIG. 11, the irregular-shaped outer ring does not have any rib, and the irregular-shaped inner ring 112 has two ribs to fix the roller along axial direction. The roller of the flexible roller bearing has infinite contact points with the raceway.

FIG. 12 is a diagram schematically showing a novel assembly of a flexspline and a wave generator including an irregular-shaped inner ring flexible ball bearing according to an embodiment of the present invention. The novel assembly of the flexspline and the wave generator is formed by fitting the irregular-shaped inner ring flexible ball bearing 121 of FIG. 9 and the conventional flexspline of FIG. 4. 1211, 1212, 1213, and 1214 respectively represent the outer ring (e.g., a flexible member) of the irregular-shaped inner ring flexible ball bearing, an irregular-shaped inner ring (e.g., a rigid member), a rolling ball, and a cage. The inner surface of the flexspline 122 is matched with the outer surface of the outer ring 121 of the irregular-shaped inner ring flexible ball bearing. Since the raceway of the irregular-shaped inner ring has a shape of ellipse in cross section, a curve connecting the centers of all the rolling balls forms an ellipse, and each of the irregular-shaped outer ring and the flexspline has a shape of an ellipse in cross section. As shown in FIG. 12, the ring has a grooved raceway, which has a shape of a single arc, an elliptic arc, or a peach tip arc in cross section. The single arc has one contact point with the rolling ball. The elliptic arc or the peach tip arc has two contact points with the rolling ball.

FIG. 13 is a diagram schematically showing a novel assembly of a flexspline and a wave generator including an irregular-shaped outer ring flexible ball bearing according to an embodiment of the present invention. The novel assembly of the flexspline and the wave generator is formed by fitting the irregular-shaped outer ring flexible ball bearing 131 and the conventional cam 132. The inner surface of the inner ring of the irregular-shaped outer ring flexible ball bearing 131 is mounted with an interference fit on the outer surface of a cam 132. The outer ring of the flexible ball bearing of FIG. 2 is replaced with the irregular-shaped outer ring of FIG. 8 to form the irregular-shaped outer ring flexible ball bearing 131. 1311, 1312, 1313, and 1314 respectively represent the irregular-shaped outer ring (e.g., a flexible member), an inner ring (e.g., a flexible member), a rolling ball, and a cage. Before installation, the irregular-shaped outer ring flexible ball bearing 131 has a shape of a circle in cross section. After the irregular-shaped outer ring flexible ball bearing 131 is installed with the cam 132, each of the flexible inner ring 1312, a curve connecting the centers of all the rolling balls 1313, and the irregular-shaped outer ring 1311 has a shape of an ellipse in cross section since the cam has a shape of an ellipse in cross section. As shown in FIG. 13, the ring has a grooved raceway, which has a shape of a single arc, an elliptic arc, or a peach tip arc in cross section. The single arc has one contact point with the rolling ball. The elliptic arc or the peach tip arc has two contact points with the rolling ball.

Below, the embodiments are described in detail in cooperation with the drawings.

### Embodiment 1—Irregular-Shaped Inner Ring Flexible Ball Bearing

As shown in FIG. 9, the irregular-shaped inner ring flexible ball bearing is formed by fitting the irregular-shaped inner ring 92 of FIG. 6, the conventional outer ring 91 of FIG. 2, and the rolling balls 93. All the rolling balls are uniformly separated by a cage 94 in a circumferential direction. Except for the inner ring of the conventional flexible ball bearing, the grooved raceway of the inner ring of the conventional flexible ball bearing is directly formed on a camshaft to fabricate the irregular-shaped inner ring 92. The grooved raceway or the rib of the irregular-shaped inner ring 92 has a shape of an ellipse in cross section. The outer ring 91 is the same or similar to the outer ring of the conventional flexible ball bearing. The cross-sectional shape of the grooved raceway of the outer ring 91 or the irregular-shaped inner ring 92 is a single arc (having one contact point with the rolling ball) of FIG. 7(A), elliptic arc (having two contact points with the rolling ball) of FIG. 7(B), or a peach tip arc (having two contact points with the rolling ball) of FIG. 7(C). According to the total contact points of one rolling ball and the raceways of the inner ring and the outer ring, the irregular-shaped inner ring flexible ball bearing is divided into (1) an irregular-shaped inner ring two-point contact flexible ball bearing (two-point contact is acquiescent but not express), (2) an irregular-shaped inner ring three-point contact flexible ball bearing, and (3) an irregular-shaped inner ring four-point contact flexible ball bearing. The number of points that the rolling ball contacts the grooved raceway of the outer ring increases to help reduce warps along a tooth-width direction of the flexspline and twists along a circumferential direction of the flexspline, thereby increasing the gearing precision and operating life of the harmonic driving device.

The outer ring is made of bearing steel. The fabrication method of the outer ring is as same as the fabrication method of the outer ring of the conventional flexible bearing. The irregular-shaped inner ring is made of bearing steel or medium-carbon steel. The grooved raceway of the irregular-shaped inner ring is processed by inductive quenching heat treatment, carburized treatment, or carbonitriding treatment when the irregular-shaped inner ring is made of medium-carbon steel. The rolling element is made of bearing steel, stainless bearing steel, or engineering ceramic. The rolling ball is embedded between the grooved raceways of the two rings when the outer ring is heated and expanded or when the outer ring is mechanically clamped and elastically deformed. Each of the outer ring 91 and the irregular-shaped inner ring 92 has a shape of a circle in cross section before the outer ring 91 is matched with the irregular-shaped inner ring 92. Each of the outer ring 91 and the irregular-shaped inner ring 92 has a shape of an ellipse in cross section after the outer ring 91 is matched with the irregular-shaped inner ring 92, as shown in FIG. 9.

For the irregular-shaped inner ring flexible bearing, the grooved raceway is directly formed on the camshaft to fabricate the irregular-shaped inner ring. After the grooved raceway of the inner ring is accurately processed and formed, the geometric precision, the precision of shape and position in all directions of the grooved raceway, and the press stress at all points of the grooved raceway keep unchanged to help improve the operating precision of the bearing, thereby increasing the gearing precision and operating reliability of the harmonic driving device. For the inner ring of the conventional flexible bearing, a single arc grooved raceway is used an example. The inner ring has a shape of a circle in cross section and the grooved raceway has a shape of a strict arc in cross section after processing the inner ring and before fitting the inner ring. The cross-sectional shape of the inner ring is forcedly turned into an ellipse when an ellipse-shaped cam is pressed into the inner ring. The grooved raceway crossed by normal planes respectively passing different points of the bottom of the grooved raceway does not have shapes of strict arcs. The radii of curvature of all positions of the grooved raceway are unequal. The widths of all positions of the grooved raceway are unequal. All positions of the grooved raceway have different distances from the bottom of the grooved raceway to the inner surface (e.g., the outer surface of the cam) of the grooved raceway. The press stress at some points of the raceway is turned into a tensile stress due to the deformation of the ring. The geometric error caused by installation and the unfavourable stress will influence the operating precision of the bearing and the gearing precision and operating life of the harmonic driving device.

### Embodiment 2—Novel Assembly of Flexspline and Wave Generator Including Irregular-Shaped Double Ring Flexible Ball Bearing

From FIG. 10, it is known that the novel assembly of the flexspline and the wave generator is the irregular-shaped double ring flexible ball bearing (both are named undiscriminatingly in the following description). The irregular-shaped double ring flexible ball bearing has all functions of the novel assembly of the flexspline and the wave generator. The irregular-shaped outer ring is a flexible ring and the outer surface of the irregular-shaped outer ring has a flexspline. The irregular-shaped inner ring is a shaft coupling inner ring. The raceway is directly formed on the camshaft and the raceway has a shape of an ellipse in cross section. The hole and the groove of the irregular-shaped inner ring are connected with a drive shaft. The irregular-shaped double ring flexible ball bearing 10 is formed by fitting the irregular-shaped outer ring 101 of FIG. 8, the irregular-shaped inner ring 102 of FIG. 6, and the rolling balls 103. The rolling balls 103 are separated by the cage 104 in a circumferential direction.

Except for the inner ring of the conventional flexible ball bearing, the grooved raceway of the inner ring of the conventional flexible ball bearing is directly formed on the camshaft to fabricate the irregular-shaped inner ring 102. Each of the grooved raceway and the rib of the irregular-shaped inner ring 102 has a shape of an ellipse in cross section. Except for the outer ring of the conventional flexible ball bearing, the grooved raceway of the outer ring of the conventional flexible ball bearing is directly formed on the flexspline to fabricate the irregular-shaped outer ring 101. Each of the grooved raceway and the rib of the irregular-shaped outer ring 101 has a shape of a circle in cross section before installation. Each of the grooved raceway and the rib of the irregular-shaped outer ring 101 has a shape of an ellipse in cross section after installation. The cross-sectional shape of the grooved raceway of the irregular-shaped outer ring 101 or the irregular-shaped inner ring 102 is a single arc (having one contact point with the rolling ball) of FIG. 7(A), elliptic arc (having two contact points with the rolling ball) of FIG. 7(B), or a peach tip arc (having two contact points with the rolling ball) of FIG. 7(C). According to the total contact points of one rolling ball and the raceways of the inner ring and the outer ring, the irregular-shaped double ring flexible ball bearing is divided into (1) an irregular-shaped double ring two-point contact flexible ball bearing (two-point contact is acquiescent but not express), (2) an irregular-shaped double ring three-point contact flexible ball bearing, and (3) an irregular-shaped double ring four-point contact flexible ball bearing. The number of points that the rolling ball contacts the grooved raceway of the irregular-shaped outer ring increases to help reduce warps along a tooth-width direction of the flexspline and twists along a circumferential direction of the flexspline, thereby increasing the gearing precision and operating life of the harmonic gear drive.

The irregular-shaped outer ring is made of carburized steel or alloy steel. The irregular-shaped inner ring is made of bearing steel or medium-carbon steel. The raceways of the two irregular-shaped rings are processed by inductive quenching heat treatment, carburized treatment, or carbonitriding treatment when the irregular-shaped inner ring is made of medium-carbon steel. The rolling ball is made of bearing steel, stainless steel, or engineering ceramic. The rolling ball is embedded between the grooved raceways of the two irregular-shaped rings when the irregular-shaped outer ring is heated and expanded or when the irregular-shaped outer ring is mechanically clamped and elastically deformed.

The irregular-shaped double ring flexible ball bearing has all advantages of the irregular-shaped inner ring flexible ball bearing of embodiment 1. Due to using the irregular-shaped outer ring, the irregular-shaped double ring flexible ball bearing has the following advantages: (1) The flexspline and the grooved raceway are installed on the same component in a clamping and positioning process, thereby improving each other's positioning precision. (2) In the conventional technology, the outer ring skids with respect to the flexspline in a circumferential direction, thereby causing the fretting wear of their matched surfaces and reducing the gearing precision. However, the irregular-shaped double ring flexible ball bearing can overcome these problems. (3) In the conventional technology, the outer ring of the flexible bearing made of low-toughness material, such as bearing steel, easily fractures and fails under the repeated action of bending stress. However, the irregular-shaped double ring flexible ball bearing can overcome these problems. The advantages are very helpful in improving the gearing precision and operating life of the harmonic gear drive.

### Embodiment 3—Novel Assembly of Flexspline and Wave Generator Including Irregular-Shaped Double Ring Flexible Roller Bearing

From FIG. 11, it is known that the novel assembly of the flexspline and the wave generator includes the irregular-shaped double ring flexible roller bearing is the irregular-shaped double ring flexible roller bearing (both are named undiscriminatingly in the following description). The irregular-shaped double ring flexible roller bearing has all functions of the novel assembly of the flexspline and the wave generator. The irregular-shaped outer ring is a flexible ring and the outer surface of the irregular-shaped outer ring has a flexspline. The irregular-shaped inner ring is a shaft coupling inner ring. The raceway is formed on the camshaft and the raceway has a shape of an ellipse in cross section. The hole and the groove of the irregular-shaped inner ring are connected with a drive shaft. The irregular-shaped double ring flexible roller bearing 11 is formed by fitting the irregular-shaped outer ring 111 of FIG. 8, the irregular-shaped inner ring 112 of FIG. 6, and the rollers 113. The rolling balls 113 are separated by the cage 114 in a circumferential direction. The irregular-shaped inner ring 112 is a cam with a linear raceway. Each of the raceway and the rib of the irregular-shaped inner ring 112 has a shape of an ellipse in cross section. The raceway of the irregular-shaped inner ring is a linear raceway with two ribs. The irregular-shaped outer ring 111 is a flexspline with a linear raceway. The raceway is directly formed on the inner surface of the flexspline to fabricate the irregular-shaped outer ring 111. The raceway of the irregular-shaped outer ring is a linear raceway without any rib. Before installation, the irregular-shaped outer ring has a shape of a circle in cross section. After installation, the cross-sectional shape of the irregular-shaped outer ring is forcedly turned into an ellipse.

In the embodiment, the raceway of the irregular-shaped outer ring 111 does not have any rib, the raceway of the irregular-shaped inner ring 112 has two ribs, and the rib of the ring limits the axial movement of the roller 113. Since the irregular-shaped outer ring 111 does not have any rib, the irregular-shaped outer ring 111 is a separable ring, which is very helpful in fitting, assembling, and disassembling the bearing. The irregular-shaped ring flexible roller bearing avoids the wear and crush of the rolling element caused by the ring during the assembly process of the flexible ball bearing and the irregular-shaped flexible ball bearing. The state that the roller of the irregular-shaped ring flexible roller bearing contacts the raceway of the ring belongs to line contact with infinite contact points of FIG. 7(D). Line contact is very helpful in reducing warps along a tooth-width direction of the flexspline and twists along a circumferential direction of the flexspline. Compared with a point contact pair, a line contact pair has high contact stiffness and low contact stress, which are very helpful in improving the gearing precision and operating life of the harmonic gear drive.

The irregular-shaped outer ring is made of carburized steel or alloy steel. The raceway of the irregular-shaped outer ring is processed by inductive quenching heat treatment, carburized treatment, or carbonitriding treatment. The irregular-shaped inner ring is processed by normal quenching heat treatment or tempering heat treatment. The rolling element is made of bearing steel, stainless steel, or engineering ceramic. The fitting method of the irregular-shaped inner ring, the irregular-shaped outer ring, and the rollers is similar to that of the conventional roller bearing.

The irregular-shaped double ring flexible roller bearing has all advantages of the irregular-shaped double ring flexible ball bearing of embodiment 2. Besides, the irregular-shaped double ring flexible roller bearing has other advantages mentioned above, such as a simple and damage-free assembly and a line contact state that the rolling element has infinite contact points with the raceway of the irregular-shaped outer ring since the rolling element is a roller. The irregular-shaped double ring flexible roller bearing has these advantages which are helpful in improving the gearing precision and operating life of the harmonic gear drive.

### Embodiment 4—Novel Assembly of Flexspline and Wave Generator Including Irregular-Shaped Inner Ring Flexible Ball Bearing

The novel assembly of the flexspline and the wave Generator including the irregular-shaped inner ring flexible ball bearing is shown in FIG. 12. The novel assembly of the flexspline and the wave generator including the irregular-shaped inner ring flexible ball bearing is formed by fitting the irregular-shaped inner ring flexible ball bearing 121 of embodiment 1 of FIG. 9 to the flexspline 122 of FIG. 4. The irregular-shaped inner ring flexible ball bearing 121 includes an outer ring 1211, an irregular-shaped inner ring 1212 rolling balls 1213, and a cage 1214. The irregular-shaped inner ring flexible ball bearing 121 and the method for fabricating the same are described as embodiment 1. The fabrication method of the flexspline 122 is the same to that of the conventional flexspline. After the irregular-shaped inner ring flexible ball bearing 121 and the flexspline 122 are fabricated, the irregular-shaped inner ring flexible ball bearing 121 is matched with the flexspline 122 to fabricate the novel assembly of the flexspline and the wave generator of embodiment 4. During installation, the outer surface of the outer ring of the irregular-shaped inner ring flexible ball bearing 121 is matched with the inner surface of the flexspline 122. Before installation, the flexspline 122 has a shape of a circle in cross section, as shown in FIG. 4. After installation, the cross sectional shape of the flexspline is forcedly turned into an ellipse shown in FIG. 12.

The novel assembly of the flexspline and the wave generator includes the irregular-shaped inner ring flexible ball bearing using the irregular-shaped inner ring and organizationally integrates the cam with the inner ring, wherein the ball has three contact points or four contact points with the raceways of the ring. Compared with the conventional assembly, the novel assembly of the flexspline and the wave generator has the following advantages: (1) The raceway of the inner ring obtains the very high processing precision, wherein the precision keeps unchanged during installation and after installation. (2) The press stress obtained during processing and forming the raceway of the inner ring is not turned into a tensile stress due to the deformation of the raceway during installation. (3) The warps along a tooth-width direction of the flexspline and the twists along a circumferential direction of the flexspline are reduced or avoided. Thus, compared with the conventional assembly of the flexspline and the wave generator, the novel assembly of the flexspline and the wave generator has the higher gearing precision and the longer operating life.

### Embodiment 5—Novel Assembly of Flexspline and Wave Generator Including Irregular-Shaped Outer Ring Flexible Ball Bearing

The novel assembly of the flexspline and the wave generator including the irregular-shaped outer ring flexible ball bearing is shown in FIG. 13. As shown in FIG. 13, the novel assembly of the flexspline and the wave generator is formed by fitting the irregular-shaped outer ring flexible ball bearing 131 to the conventional cam 132. The inner surface of the inner ring of the irregular-shaped outer ring flexible ball bearing 131 is mounted with an interference fit on the outer surface of the cam 132. The irregular-shaped outer ring flexible ball bearing 131 is formed by replacing the outer ring of the flexible ball bearing of FIG. 2 with the irregular-shaped outer ring of FIG. 8. 1311, 1312, 1313, and 1314 respectively represent the irregular-shaped outer ring (e.g., a flexible member), an inner ring (e.g., a flexible member), a rolling ball, and a cage. Before installation, the irregular-shaped outer ring flexible ball bearing 131 has a shape of a circle in cross section. After the irregular-shaped outer ring flexible ball bearing 131 is installed with the cam 132, each of the flexible inner ring 1312, a curve connecting the centers of all the rolling balls 1313, and the irregular-shaped outer ring 1311 has a shape of an ellipse in cross section since the cam has a shape of an ellipse in cross section. As shown in FIG. 13, the ring has a grooved raceway, which has a shape of a single arc, an elliptic arc, or a peach tip arc in cross section. The single arc has one contact point with the rolling ball. The elliptic arc or the peach tip arc has two contact points with the rolling ball.

The novel assembly of the flexspline and the wave generator includes the irregular-shaped outer ring flexible ball bearing using the irregular-shaped outer ring and organizationally integrates the flexspline with the outer ring, wherein the ball has three contact points or four contact points with the raceways of the ring. Compared with the conventional assembly, the novel assembly of the flexspline and the wave generator has the following advantages: (1) In the conventional technology, the rotating speed of the outer ring does not synchronize with the rotating speed of the flexspline, thereby causing the problem of the fretting wear of their matched surfaces. However, the problem can be avoided. (2) The bending fracture of the outer ring made of high-carbon-chromium bearing steel can be avoided. (3) The positioning precision of the flexspline with respect to the outer ring can be improved. (4) The warps along a tooth-width direction of the flexspline and the twists along a circumferential direction of the flexspline are reduced or avoided. Thus, compared with the conventional assembly of the flexspline and the wave generator, the novel assembly of the flexspline and the wave generator has the higher gearing precision and the longer operating life.

It is noted that the ring of the roller bearing has a rib to limit the axial movement of the roller. However, the rib is equivalent to a stiffener for the ring. The ring having a rib is difficulty deformed or unable to be deformed. Thus, a flexible roller bearing is not used. When the irregular-shaped inner ring is used, the raceway with two ribs can be adopted (and the raceway of matched outer ring or irregular-shaped outer ring does not need any rib) since the irregular-shaped inner ring does not need to be deformed. Accordingly, it is possible to design, produce, and apply a flexible roller bearing and create a new application field for roller bearings.

The outer ring and the inner ring of the conventional flexible bearing have to be flexible rings, or their given functions are not performed. The irregular-shaped outer ring and the inner ring of the irregular-shaped outer ring flexible bearing are still flexible rings. However, the irregular-shaped inner rings of the irregular-shaped inner ring flexible bearing and the irregular-shaped double ring flexible bearing are not flexible rings, but rigid rings/shafts. Thus, the definition of the flexible bearing is changed.

The conventional assembly of the flexspline and the wave generator includes a cam, a (two-contact) flexible ball bearing, and a flexspline. The conventional assembly has only one type and belongs to a three-piece suit. The novel assembly of the flexspline and the wave generator includes an irregular-shaped ring flexible bearing. The novel assembly is divided into 11 types. The novel assembly belongs to a two-piece suit or a one-piece suit. For clearance, the types of the novel assembly are listed in the following table.

| | | | Number of |
|---|---|---|---|
| | | | members forming |
| | | Member 2 | novel assembly of |
| Serial | Member 1 | Cam or | flexspline and |
| Number | Flexible bearing | Flexspline | wave generator |
| 1 | Irregular-shaped inner | Flexspline | Two-piece suit |
| | ring (two-contact) flexible ball | | |
| | bearing | | |
| 2 | Irregular-shaped inner ring | Flexspline | Two-piece suit |
| | three-contact flexible ball | | |
| | bearing | | |
| 3 | Irregular-shaped inner ring | Flexspline | Two-piece suit |
| | four-contact flexible ball bearing | | |
| 4 | Irregular-shaped outer | Cam | Two-piece suit |
| | ring (two-contact) flexible ball | | |
| | bearing | | |
| 5 | Irregular-shaped outer ring | Cam | Two-piece suit |
| | three-contact flexible ball | | |
| | bearing | | |
| 6 | Irregular-shaped outer ring | Cam | Two-piece suit |
| | four-contact flexible ball bearing | | |
| 7 | Irregular-shaped double | / | One-piece suit |
| | ring (two-contact) flexible ball | | |
| | bearing | | |
| 8 | Irregular-shaped double ring | / | One-piece suit |
| | three-contact flexible ball | | |
| | bearing | | |
| 9 | Irregular-shaped double ring | / | One-piece suit |
| | four-contact flexible ball bearing | | |
| 10 | Irregular-shaped inner ring | Flexspline | Two-piece suit |
| | flexible roller bearing | | |
| 11 | Irregular-shaped double ring | / | One-piece suit |
| | flexible roller bearing | | |

The irregular-shaped inner ring replaces the conventional cam and the inner ring of the conventional flexible bearing. The irregular-shaped inner ring is a camshaft with a raceway. The raceway has a shape of an ellipse in cross section. After replacing the conventional cam and the inner ring of the conventional flexible bearing, the irregular-shaped inner ring has the following advantages: (1) Since the inner ring of the conventional flexible bearing has a very thin wall and a very narrow width, the inner ring of the conventional flexible bearing difficulty obtains high processing precision during processing time. The irregular-shaped inner ring is different from the conventional technology. The irregular-shaped inner ring is a shaft ring/shaft that can obtain the very high processing precision. (2) The flexible inner ring needs not to be processed, thereby reducing the processing cost. (3) When the conventional flexible inner ring is mounted on the camshaft, the shape of the inner ring is forcedly turned from a circle into an ellipse to reduce the precision of the shape of the raceway and the precision of position and shape of the raceway with respect to other surfaces, and the tensile stress are produced on the surface of the grooved raceway. These problems can be avoided. Thus, the operating precision and operating reliability of the bearing is improved and the operating consumption of the bearing is reduced, thereby improving the gearing precision and operating life of the assembly of the flexspline and the wave generator.

The irregular-shaped outer ring replaces the conventional flexspline and the outer ring of the conventional flexible bearing. The irregular-shaped outer ring is still flexible. After replacing the conventional flexspline and the outer ring of the conventional flexible bearing, the irregular-shaped outer ring has the following advantages: (1) The flexible outer ring needs not to be processed to reduce the processing cost. (2) The wall of the irregular-shaped outer ring is thicker than the walls of the outer ring of the conventional flexible bearing and the flexspline, which is helpful in reducing heat deformation and processing deformation, thereby decreasing the processing cost and increasing the processing precision. (3) The irregular-shaped outer ring is processed to form the flexspline and the grooved raceway in a clamping and positioning process. Alternatively, the flexspline and the grooved raceway may be used as each other's positioning bases and processed. As a result, the positional precision of the raceway of the outer ring with respect to the flexspline. (4) The relative rotation occurs between the outer ring of the conventional flexible bearing and the flexspline during operation. Due to the relative rotation, the fretting wear of the matched surfaces of the outer ring of the conventional flexible bearing and the flexspline is produced and the gearing precision is reduced. The irregular-shaped outer ring can avoid the phenomena. (5) In the conventional technology, the outer ring made of bearing steel (having higher hardness and insufficient toughness) easily fractures and fails under the repeated action of alternating bending stress. Finally, the gearing precision and the operating life of the assembly of the flexspline and the wave generator are improved.

The irregular-shaped double rings include an irregular-shaped inner ring and an irregular-shaped outer ring. Thus, the irregular-shaped double ring flexible bearing has the advantages of the irregular-shaped inner ring flexible bearing and the irregular-shaped outer ring flexible bearing.

The force used to deform the flexspline, the outer ring, and the irregular-shaped outer ring comes from the force that the rolling element contacts the raceway of the outer ring or the irregular-shaped outer ring. In addition, the flexspline has a certain width. The warps along a tooth-width direction of the flexspline and the twists along a circumferential direction of the flexspline are reduced or avoided when the number of points that the rolling element contacts the raceway of the outer ring or the irregular-shaped outer ring (along a direction for the width of the outer ring) increases and the flexspline is deformed in a given radial direction. For the flexible ball bearing, the number of points that the rolling ball contacts the grooved raceway of the outer ring depends on the cross-sectional shape of the grooved raceway of the outer ring. For a single arc grooved raceway, there is one contact point. For an elliptic arc grooved raceway and a peach tip arc grooved raceway, there are two contact points.

As mentioned above, the irregular-shaped inner ring made the design and application of the flexible roller bearing possible. The irregular-shaped ring flexible roller bearing has the technology and quality of the irregular-shaped ring flexible ball bearing. On top of that, the irregular-shaped ring flexible roller bearing has the following advantages: (1) The outer ring or the irregular-shaped outer ring is a separable flexible ring without any rib. Thus, the bearing assembly process is simple. Also, there is no wear and crush to the rolling element during the assembly process. (2) The contact force distributed at infinite points is used to deform the flexspline, such that warps along a tooth-width direction of the flexspline and twists along a circumferential direction of the flexspline are reduced or avoided when the flexspline is deformed in a given radial direction during operation. (3) The stress that the rolling element contacts the raceway is reduced to extend the operating life of the bearing. (4) Due to (1), (2), and (3), the gearing precision and the operating life of the novel assembly of the flexspline and the wave generator including the irregular-shaped outer flexible roller bearing are improved. If a cambered roller or/and a cambered raceway is used, such as convex forms, the performance of the irregular-shaped ring flexible roller bearing will be improved.

The working surface of the ring of the bearing is collectively called a raceway. For the ball bearing, the raceway is a groove-type raceway, which is abbreviated as a grooved raceway. For the roller bearing, the raceway is a linear raceway, which is also abbreviated as a raceway.

The abovementioned roller includes a cylindrical roller and a needle roller.

The irregular-shaped outer ring has the raceway and the flexspline. The irregular-shaped inner ring has the raceway, the installing hole, and the groove. Besides, the irregular-shaped outer ring and the irregular-shaped inner ring have hole, screw holes, and shoulders for installment. These portions are adaptively designed and arranged according to the types and sizes of different harmonic gear drives, but not the focus of the discussion and disclosure of the present invention. As a result, these portions are not described and shown in the drawings of the present invention.

Although the present invention is named the assembly of the flexspline and the wave generator, the assembly of the flexspline and the wave generator is named according to its functions for input and output. The novel assembly of the flexspline and the wave generator of the present invention does not necessarily include three components (e.g., cam, flexspline, and flexible bearing) of the conventional assembly of the flexspline and the wave generator. Even if the novel assembly of the flexspline and the wave generator includes one of a cam, a flexspline, and a flexible bearing, the included one may be integrated, upgraded, or evolved. However, the novel assembly of the flexspline and the wave generator of the present invention has all functions for input and output of the conventional novel assembly of the flexspline and the wave generator. The novel assembly of the flexspline and the wave generator has better performance, higher gearing precision, and longer operating life.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

1. A novel assembly of a flexspline and a wave generator for a harmonic gear drive, wherein an outer surface of the assembly has teeth, an inner surface of the assembly has a hole and a groove connected with a drive shaft, the teeth of the outer surface is configured to generate a periodic elastic deformed wave according to a deformed regularity, the assembly comprises an irregular-shaped ring flexible bearing having at least one irregular-shaped ring, a rolling element is embedded between two rings and separated by a cage in a circumferential direction, at least one of the two rings embedding the rolling element is an irregular-shaped ring, and the irregular-shaped ring flexible bearing is selected from one of three following bearings: (1) an inner ring is matched with an irregular-shaped outer ring to form an irregular-shaped outer ring flexible bearing; (2) an outer ring is matched with an irregular-shaped inner ring to form an irregular-shaped inner ring flexible bearing; and (3) an irregular-shaped outer ring is matched with an irregular-shaped inner ring to form an irregular-shaped double ring flexible bearing; and the irregular-shaped ring differs from a standard bearing ring having a tooth-free inner surface, a tooth-free outer surface, and a shape of a circle in cross section, so as to improve operating precision and operating life of the assembly.

2. The novel assembly of the flexspline and the wave generator for the harmonic gear drive according to claim 1, further comprising a cam when the irregular-shaped ring flexible bearing is the irregular-shaped outer ring flexible bearing, an inner surface of the inner ring of the irregular-shaped outer ring flexible bearing has interference fit with an outer surface of the cam, an inner surface of the irregular-shaped outer ring has a raceway, an outer surface of the irregular-shaped outer ring has teeth, and the irregular-shaped outer ring is a flexible ring.

3. The novel assembly of the flexspline and the wave generator for the harmonic gear drive according to claim 1, further comprising a flexspline when the irregular-shaped ring flexible bearing is the irregular-shaped inner ring flexible bearing, an outer surface of the outer ring of the irregular-shaped inner ring flexible bearing has interference fit with an inner surface of the flexspline, the irregular-shaped inner ring is a cam which has a raceway on its outer surface, the irregular-shaped inner ring is a rigid shaft, a shape of the raceway in cross section depends on number of waves driven by a harmonic gear drive, the shape is an ellipse used for a double-wave drive, and the shape is a three-petaled round used for a triple-wave drive.

4. The novel assembly of the flexspline and the wave generator for the harmonic gear drive according to claim 1, wherein the irregular-shaped ring flexible bearing is the irregular-shaped double ring flexible bearing, an inner surface of the irregular-shaped outer ring has a raceway, an outer surface of the irregular-shaped outer ring has teeth, the irregular-shaped outer ring is a flexible ring, the irregular-shaped inner ring is a cam which has a raceway on its outer surface, the irregular-shaped inner ring is a rigid shaft, a shape of the raceway of the cam in cross section depends on number of waves driven by a harmonic gear drive, the shape is an ellipse used for a double-wave drive, and the shape is a three-petaled round used for a triple-wave drive.

5. The novel assembly of the flexspline and the wave generator for the harmonic gear drive according claim 1, wherein the rolling element is a rolling ball, the ring or the irregular-shaped ring has a raceway, which is a single arc grooved raceway having one contact point with the rolling ball, or either an elliptic arc grooved raceway or a peach tip arc grooved raceway having two contact points with the rolling ball, according to the total contact points of the rolling ball and the raceways of either the outer ring or the irregular-shaped outer ring and either the inner ring or the irregular-shaped inner ring, the irregular-shaped ring flexible bearing comprises an irregular-shaped ring two-point contact flexible ball bearing, an irregular-shaped ring three-point contact flexible ball bearing, and an irregular-shaped ring four-point contact flexible ball bearing.

6. The novel assembly of the flexspline and the wave generator for the harmonic gear drive according claim 1, wherein the rolling element is a roller, a raceway of the ring or the irregular-shaped ring is a straight line type raceway or a crowned curve type raceway, and the irregular-shaped ring flexible bearing is an irregular-shaped ring flexible roller bearing.

7. The novel assembly of the flexspline and the wave generator for the harmonic gear drive according to claim 5, wherein the grooved raceway crossed by a normal plane vertical to a tangent line to a corresponding point of a bottom of the grooved raceway includes the corresponding point and has a shape of a single arc, a pitch tip arc, or an elliptic arc.

8. The novel assembly of the flexspline and the wave generator for the harmonic gear drive according to claim 6, wherein the linear raceway crossed by a normal plane vertical to a tangent line to a corresponding point of the linear raceway includes the corresponding point and has a shape of a straight line or a crowned curve.

9. The novel assembly of the flexspline and the wave generator for the harmonic gear drive according to claim 6, wherein the irregular-shaped ring flexible roller bearing is an irregular-shaped inner ring flexible roller bearing or an irregular-shaped double ring flexible roller bearing, a raceway of the outer ring or the irregular-shaped outer ring does not have any rib, and a raceway of the irregular-shaped inner ring has a single rib or two ribs.

10. The novel assembly of the flexspline and the wave generator for the harmonic gear drive according to claim 1, wherein the irregular-shaped outer ring is made of carburized steel or alloy steel, a raceway of the irregular-shaped outer ring is processed by inductive quenching heat treatment, carburized treatment, or carbonitriding treatment, and the rolling element is made of bearing steel, stainless bearing steel, or engineering ceramic.

11. The novel assembly of the flexspline and the wave generator for the harmonic gear drive according to claim 1, wherein the irregular-shaped inner ring is made of bearing steel, stainless bearing steel, or medium-carbon steel, a raceway of the irregular-shaped inner ring is processed by inductive quenching heat treatment, carburized treatment, or carbonitriding treatment when the irregular-shaped inner ring is made of medium-carbon steel, and the rolling element is made of bearing steel, stainless bearing steel, or engineering ceramic.

12. An irregular-shaped ring flexible bearing, which has at least one irregular-shaped ring, the rolling element is embedded between two rings and separated by a cage in a circumferential direction, at least one of the two rings embedding the rolling element is an irregular-shaped ring, and the irregular-shaped ring flexible bearing is selected from one of three following bearings: an inner ring is matched with an irregular-shaped outer ring to form an irregular-shaped outer ring flexible bearing; an outer ring is matched with an irregular-shaped inner ring to form an irregular-shaped inner ring flexible bearing; and an irregular-shaped outer ring is matched with an irregular-shaped inner ring to form an irregular-shaped double ring flexible bearing, thereby improving manufacturing, installing and operating precision and operating life of the bearing.

13. The irregular-shaped ring flexible bearing according to claim 12, wherein the irregular-shaped outer ring is made of carburized steel or alloy steel, a raceway of the irregular-shaped outer ring is processed by inductive quenching heat treatment, carburized treatment, or carbonitriding treatment, and the rolling element is made of bearing steel, stainless bearing steel, or engineering ceramic; or
the irregular-shaped inner ring is made of bearing steel, stainless bearing steel, or medium-carbon steel, a raceway of the irregular-shaped inner ring is processed by inductive quenching heat treatment, carburized treatment, or carbonitriding treatment when the irregular-shaped inner ring is made of medium-carbon steel, and the rolling element is made of bearing steel, stainless bearing steel, or engineering ceramic.

14. The novel assembly of the flexspline and the wave generator for the harmonic gear drive according to claim 8, wherein the irregular-shaped ring flexible roller bearing is an irregular-shaped inner ring flexible roller bearing or an irregular-shaped double ring flexible roller bearing, the raceway of the outer ring or the irregular-shaped outer ring does not have any rib, and a raceway of the irregular-shaped inner ring has a single rib or two ribs.
